(19) United States
(12) Patent Application Publication
(10) Pub. No.: US 2012/0066698 A1
(43) Pub. Date: Mar. 15, 2012

(54) DYNAMIC DATA FLOW TRACKING METHOD, DYNAMIC DATA FLOW TRACKING PROGRAM, AND DYNAMIC DATA FLOW TRACKING APPARATUS

(75) Inventor: Kazuo Yanoo, Tokyo (JP)

(73) Assignee: NEC CORPORATION, Minato-ku, Tokyo (JP)

(21) Appl. No.: 13/321,753

(22) PCT Filed: May 18, 2010
(86) PCT No.: PCT/JP2010/003346

§ 371 Date: Nov. 21, 2011

(30) Foreign Application Priority Data
May 20, 2009 (JP) 2009-122345

(51) Int. Cl. G06F 9/54

(52) U.S. Cl. 719/330

(57) ABSTRACT

A dynamic data flow tracking apparatus, a dynamic data flow tracking method, and a dynamic data flow tracking program are provided which can raise the dynamic data flow analysis speed for a program linked to plural shared libraries. A specification of data passing between functions included in a shared library is defined in a signature, which is stored in a storage unit (108). At least a part of the propagation of a tag between the functions in a call destination is skipped by referring to the signature stored in the storage unit (108) at the time of giving a call to a function defined in the signature from a program.

### TECHNICAL FIELD

The present invention relates to a dynamic data flow tracking apparatus, a dynamic data flow tracking method, and a dynamic data flow tracking program, and more particularly, to a dynamic data flow tracking apparatus, a dynamic data flow tracking method, and a dynamic data flow tracking program using information on a specification of a library.

### BACKGROUND ART

A technique of partially rewriting the executable code of a program at the time of execution and embedding a code for performance measurement, bug detection, or the like is referred to as a binary instrumentation. By employing the binary instrumentation technique, a user can analyze how to exchange data in a process at the time of execution. This data analysis technique is referred to as dynamic data flow analysis.

In dynamic data flow analysis, a numerical value is added to input data in a process of a program in execution. This numerical value is referred to as a “tag”. The input data means data read from a file or data received via a network. The tag means information indicating what path the data is input through. In the dynamic data flow analysis, whenever data having a tag added thereto is copied to a register or a memory in the process, the tag added to the data also propagates (is copied). Accordingly, it is possible to judge what input originates the input data.

In the dynamic data flow analysis, an executable code of a program is divided into units referred to as a basic code and instrumentation is performed on the basic blocks. The instrumentation is a function of reading an executable code of a program, performing a prejudged process on the executable code to change the executable code, and executing the changed executable code. An example of the instrumentation function is disclosed in Non-patent Document 1.

By applying dynamic data flow analysis to information security, a user can find out an attack on a weakness in a program or leakage of information when executing the program.

A technique of applying dynamic data flow analysis to the discovery of an attack on a weakness in a program is disclosed in Non-patent Document 2. Such a type of attack to execute an arbitrary code on the weakness of a program, such as a buffer overflow attack, is carried out in the two following steps.

(1) An illegal code is loaded into the program from the outside via a network.

(2) The control of the program is transferred to the loaded illegal code.

In the technique disclosed in Non-patent Document 2, it is judged whether the step (2) occurs by determining whether the execution control should be transferred to data read from an unreliable information source (for example, reception of data via the Internet) or not. Through the use of this processing, a user can detect or prevent the buffer overflow attack.

A technique of applying dynamic data flow analysis to leakage of information by spyware or the like is disclosed in Non-patent Document 3. The leakage of information by spyware is caused when a program transmits secret information to the outside such as a network contrary to a user's intention. In the technique disclosed in Non-patent Document 3, the leakage of information is discovered by determining whether a process outputs data read from a high-secrecy information source such as a document file on a PC (Personal Computer) to an unreliable destination, such as transmission of data via the Internet or the like using the dynamic data flow analysis.

As described above, a problem related to information security can be discovered by the use of the dynamic data flow analysis. However, the dynamic data flow analysis has a problem in that the program execution speed is lowered because the exchange of internal data is sequentially recorded one by one when executing the program.

Regarding this problem, several techniques of raising the program execution speed have been proposed. In the technique disclosed in Non-patent Document 4, when a register used in a basic block is clean (in a state not originating from secret information) when executing the basic block, a code (fast path code) in which a data tracing process is skipped except for loading from a memory to the register is executed. On the other hand, when the register used in the basic block is not clean, a code (track path code) in which the data tracing process is embedded is executed.

### Related Documnent

### Non-Patent Documnent

[Non-patent Document 1] Chi-keung Luk, Robert Cohn, Robert Muth, Harish Patil, Artur Klauser, Geoff Lowney, Steven Wallace, Vijay Janapa, Reddi Kim Hazelwood, Pin: Building Customized Program Analysis Tools with Dynamic Instrumentation, In Programming Language Design and Implementation, Chicago, Ill., June 2005

[Non-patent Document 2] James Newsome, Dawn Song, Dynamic Taint Analysis for Automatic Detection, Analysis, and Signature Generation of Exploits on Commodity Software, NDSS 2005

[Non-patent Document 3] Neil Vachharajani, Matthew J. Bridges, Jonathan Chang, Ram Rangan, Guilherme Ottani, Jason A. Blome, George A. Reis, Manish Vachharajani, and David I. August, RIFLE: An Architectural Framework for User-Centric Information-Flow Security, ACM/IEEE International Symposium on Microarchitecture (MICRO' 04) 2004

[Non-patent Document 4] Feng Qin, Cheng Wang, Zhenmin Li, Ho-seop Kim, Yuanyuan Zhou, and Youfeng Wu, LIFT: A Low-Overhead Practical Information Flow Tracking System for Detecting Security Attacks, ACM/IEEE International Symposium on Microarchitecture (MICRO' 06), 2006

### DISCLOSURE OF THE INVENTION

### Technical Goal

However, in an application executed in a client machine, shared libraries such as many DLLs (Dynamic Link Libraries) are linked to a program. Accordingly, when this program is analyzed using dynamic data flow analysis, it is necessary to sequentially track data passing in the shared libraries linked to the program one by one, thereby causing a problem with a decrease in execution speed.

The invention is made to solve the above-mentioned problem. A goal of the invention is to provide a dynamic data flow tracking apparatus, a dynamic data flow tracking method, and a dynamic data flow tracking program which can raise the dynamic data flow analysis speed for a program linked to plural shared libraries.

### Technical Solution

According to an aspect of the invention, there is provided a dynamic data flow tracking method of dynamically tracking a data flow by setting a tag for data in a process and causing the tag to propagate with data passing in the process, wherein a specification of the data passing between functions included in a shared library is defined in a signature, and at least a part of the propagation of the tag between the functions is skipped by referring to the signature at the time of giving a call to the functions defined in the signature from a program.

### Advantageous Effect

According to the aspect of the invention, it is possible to provide a dynamic data flow tracking apparatus, a dynamic data flow tracking method, and a dynamic data flow tracking program which can raise the dynamic data flow analysis speed for a program linked to plural shared libraries.

### BRIEF DESCRIPTION OF THE DRAWINGS

The above-mentioned goal, other goals, features, and advantages of the invention will become more apparent from the following embodiments to be described with reference to the following drawings.

FIG. 1 is a block diagram illustrating a dynamic data flow analysis apparatus according to a first embodiment of the invention.

FIG. 2 is a block diagram illustrating the dynamic data flow analysis apparatus according to the first embodiment of the invention.

FIG. 3 is a conceptual diagram illustrating a process of embedding a code in a basic block according to the first embodiment of the invention.

FIG. 4 is a diagram illustrating an API signature according to the first embodiment of the invention.

FIG. 5 is a diagram illustrating an API address map according to the first embodiment of the invention.

FIG. 6 is a diagram illustrating a shared library address list according to the first embodiment of the invention.

FIG. 7 is a flowchart illustrating the process of embedding a code in a basic block according to the first embodiment of the invention.

FIG. 8A is a diagram illustrating an example of a function call code from a shared library according to the first embodiment of the invention.

FIG. 8B is a diagram illustrating an executable code according to the first embodiment of the invention.

FIG. 9 is a diagram illustrating an executable code having an API tracking code embedded therein according to the first embodiment of the invention.

FIG. 10 is a block diagram illustrating a dynamic data flow analysis apparatus according to a second embodiment of the invention.

FIG. 11 is a diagram illustrating a basic block according to the second embodiment of the invention.

FIG. 12 is a flowchart illustrating a generating process of a basic block according to the second embodiment of the invention.

FIG. 13 is a flowchart illustrating a generating process of a full tracking code according to the second embodiment of the invention.

FIG. 14 is a diagram illustrating an executable code executed a function call embedding process according to the second embodiment of the invention.

FIG. 15 is a diagram illustrating an executable code executed a return process embedding process according to the second embodiment of the invention.

FIG. 16 is a flowchart illustrating an intra-API tracking code generating process according to the second embodiment of the invention.

FIG. 17 is a block diagram illustrating a dynamic data flow analysis apparatus according to a third embodiment of the invention.

FIG. 18 is a flowchart illustrating a conservative function call process embedding process according to the third embodiment of the invention.

FIG. 19 is a diagram illustrating an executable code executed the conservative function call process embedding process according to the third embodiment of the invention.

FIG. 20 is a block diagram illustrating a dynamic data flow analysis apparatus according to a fourth embodiment of the invention.

### DESCRIPTION OF EMBODIMENTS

### First Embodiment

Hereinafter, embodiments of the invention will be described with reference to the accompanying drawings.

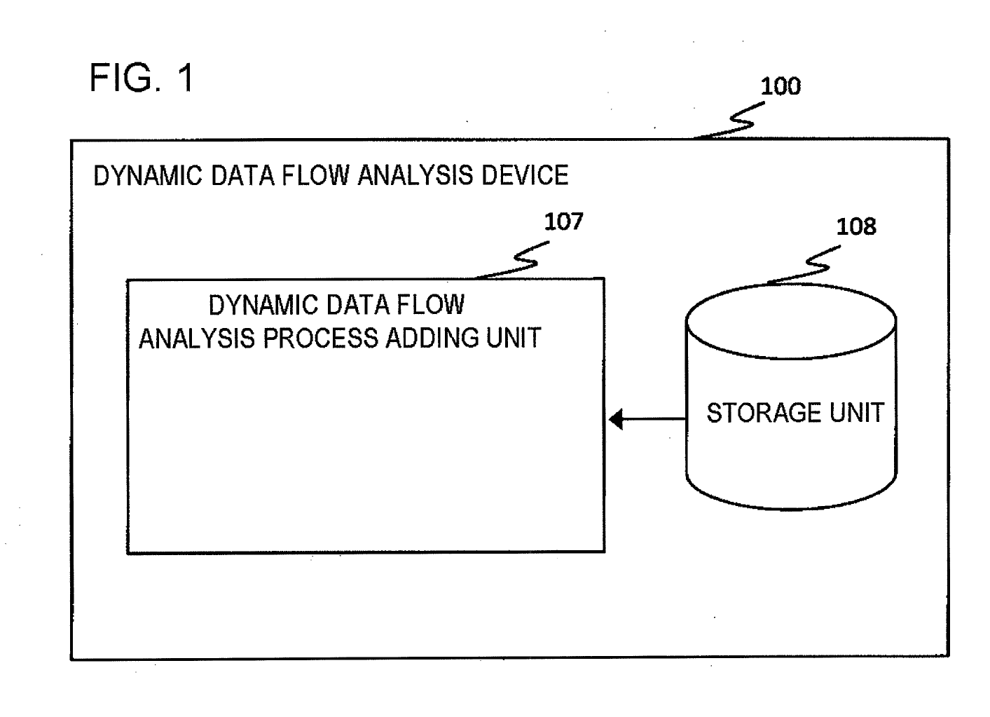

First, a dynamic data flow analysis apparatus according to a first embodiment of the invention will be schematically described with reference to FIG. 1. The dynamic data flow analysis apparatus 100 according to the first embodiment of the invention includes a dynamic data flow analysis process adding unit 107 and a storage unit 108. The dynamic data flow analysis apparatus according to this embodiment dynamically tracks a data flow by setting a tag indicating an input path of data for the data in a process, and causing the tag to propagate with the data passing in the process.

The storage unit 108 stores a signature in which a specification of passing the data between functions (user codes) included in a shared library is defined. The dynamic data flow analysis process adding unit 107 skips at least a part of the propagation of the tag between the functions and preferably causes the tag to propagate in a bundle by referring to the signature at the time of giving a call to a function defined in the signature (hereinafter, also referred to as an API (Application Program Interface) signature) form a program. Here, the dynamic data flow analysis process adding unit 107 according to this embodiment adds a tag propagation to before and after a function call or to a function which is called when the function is called. In this embodiment, an example which a tag propagates in a bundle is described, but at least a part of the propagation of the tag may be skipped, whereby it is possible to reduce processes accompanied with the tag propagation process and thus to raise the speed.

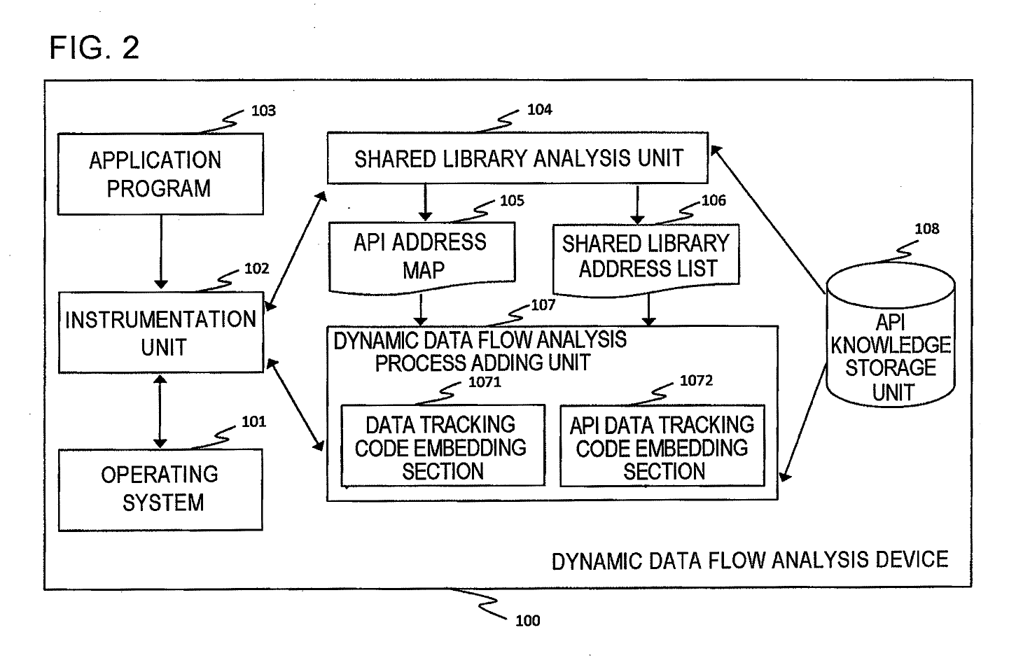

The detailed configuration of the dynamic data flow analysis apparatus according to the first embodiment of the invention will be described below with reference to FIG. 2. The dynamic data flow analysis apparatus 100 shown in FIG. 1 can be specifically illustrated as the dynamic data flow analysis apparatus 100 shown in FIG. 2. The dynamic data flow analysis apparatus 100 can be embodied by software executed by a computer operating under the control of programs, for example, a central processing unit (CPU, which is not shown in FIG. 2). The dynamic data flow analysis apparatus 100 includes an operating system 101, an instrumentation unit 102, an application program 103, a shared library analysis unit 104, a dynamic data flow analysis process adding unit 107, and an API knowledge storage unit 108. The dynamic data flow analysis process adding unit 107 shown in FIG. 1 corresponds to the dynamic data flow analysis process adding unit 107 shown in FIG. 2.

The storage unit 108 shown in FIG. 1 corresponds to the API knowledge storage unit 108 shown in FIG. 2.

The operating system 101 is software providing an interface which is abstracted from hardware to application software in a computer, and is one of basic software.

The instrumentation unit 102 reads an executable code of the application program 103 and divides the read executable code into basic blocks. The instrumentation unit 102 makes a change of adding a dynamic data flow analysis process to the basic blocks by using the dynamic data flow analysis process adding unit 107, and stores the changed basic blocks in a data cache in the instrumentation unit 102.

The application program 103 is a program which is executed by a PC. The shared library analysis unit 104 receives the executable code loaded by the instrumentation unit 102 and information of the shared libraries linked to the executable code as an input. The shared library analysis unit 104 outputs an API address map 105 and a shared library address list 106 on the basis of the input and the information in the API knowledge storage unit 108.

The dynamic data flow analysis process adding unit 107 includes a data tracking code embedding section 1071 and an API data tracking code embedding section 1072. The dynamic data flow analysis process adding unit 107 receives the basic blocks as an input from the instrumentation unit 102. The dynamic data flow analysis process adding unit 107 generates a code for detecting the dependency of data input and output to and from the basic blocks on the basis of the API address map 105, the shared library address list 106, and information in the API knowledge storage unit 108 and embeds the code into the basic blocks. Thereafter, the dynamic data flow analysis process adding unit 107 outputs the generated basic blocks to the instrumentation unit 102.

The API knowledge storage unit 108 stores information of the API signature. Here, the API signature is information of the API of a function of a shared library called by a program. The API signature is information defining what API function causes a data flow (data passing) between parameters and return values. The API signature includes information for identifying API functions, such as a module name or a function name, and information defining what data flow (data passing) the call of the API function causes. The API function means a function defined in the API signature. In this embodiment, it is assumed that the all of functions included in the shared libraries are defined in the API signature. That is, in this embodiment, all of the functions in the shared libraries are the API functions.

The dynamic data flow analysis apparatus 100 is embodied by software by causing a CPU to execute a computer program, but may be embodied by hardware. The computer program executed by the CPU may be provided from a recording medium having the computer program or may be provided via the Internet or other communication media. Examples of the recording medium include a flexible disk, a hard disk, a magnetic disc, a magneto-optical disc, a CD-ROM, a DVD, a ROM cartridge, a RAM memory cartridge having a backup battery, a flash memory cartridge, and a nonvolatile RAM cartridge. Examples of the communication media include a wired communication medium such as a telephone circuit and a radio communication medium such as a microwave circuit.

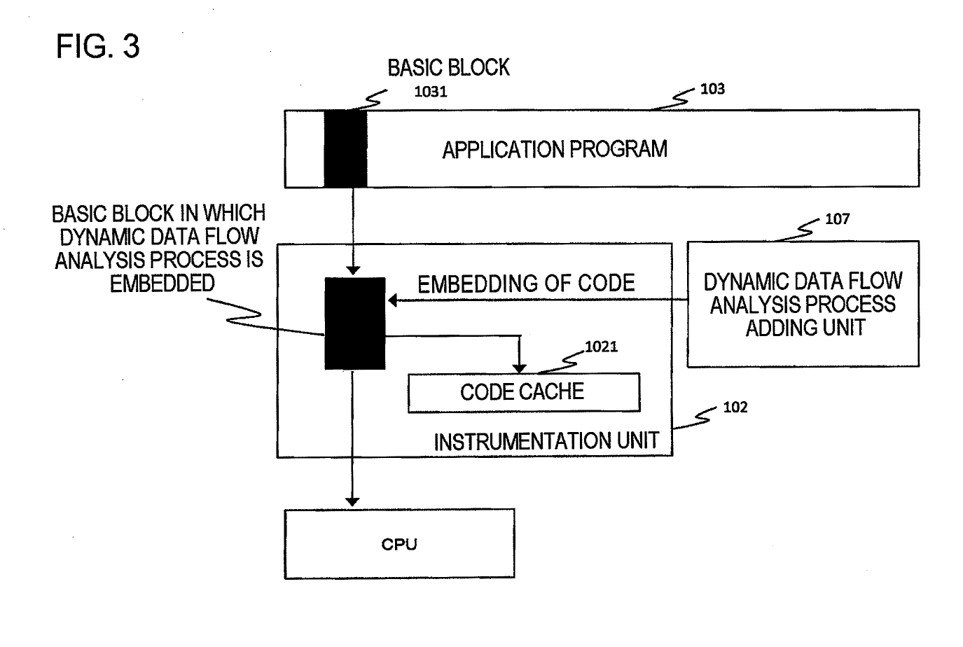

An instrumentation process mainly performed by the instrumentation unit 102 will be schematically described below with reference to FIG. 3.

In general, when a program is executed by a computer, a loader reads an executable code of the program and an executable code of a shared library linked to the program. The loader transfers the control to an execution start position of the program and starts the execution of the read program code on a memory.

On the other hand, the instrumentation unit 102 performs the following processes. The instrumentation unit 102 gives a call to the shared library analysis unit 104 when the executable code of the program and the executable code of the shared library. The processes of the shared library analysis unit 104 will be described later. After the shared library analysis unit 104 performs the processes, the instrumentation unit 102 reads the executable codes onto the memory. The instrumentation unit 102 extracts a basic block 1031 which is a unity having the executable code from the execution start position of the executable code. Thereafter, the instrumentation unit 102 gives a call to the dynamic data flow analysis process adding unit 107 and causes the dynamic data flow analysis process adding unit 107 to perform the processes defined therein on the basic block 1031.

The dynamic data flow analysis process adding unit 107 embeds the dynamic data flow analysis process on the basic block 1031 and transfers the generated basic block 1031 to the instrumentation unit 102. The instrumentation unit 102 transfers the control to the basic block 1031 generated and executes the basic block 1031. The instrumentation unit 102 stores the generated basic block 1031 in a code cache 1021.

In the subsequent execution of the program, when it is necessary to execute the same basic block 1031, the control is transferred to the basic block 1031 after changed which is stored in the code cache 1021. By caching the changed basic block 1031, a code embedding process taking a process time is performed only once in principle. When the basic block 1031 stored in the code cache 1021 is directly branched to another basic block 1031 stored in the code cache 1021, it is possible to suppress the lowering of an execution speed of an application by employing various known speed-up means such as rewriting the basic block 1031 in the code cache 1021 which is a call source so as to be directly branched to the basic block 1031 in the code cache 1021 which is a call destination without temporarily transferring the control to the instrumentation unit 102.

The instrumentation unit 102 performs the basic block changing process on all the basic blocks 1031.

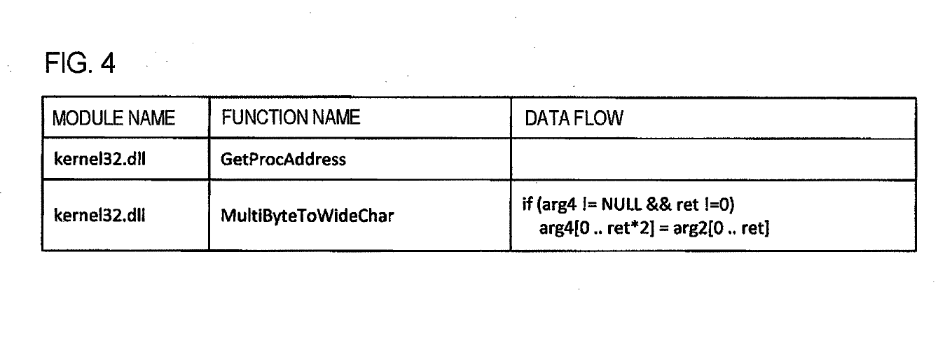

The API signature stored in the API knowledge storage unit 108 will be described below with reference to FIG. 4. In the API signature shown in FIG. 4, functions of GetProcAddress and MultiByteToWideChar mounted on a DLL of kernel32.dll which is a shared library and information on the data flows of the functions are defined.

Since the function of GetProcAddress in FIG. 4 does not cause a data flow between the parameters of the API functions and between the parameters and the return values, information on the data flow is not defined in the API signature. On the other hand, since the function of MultiByteToWideChar causes a data flow between a third parameter and a fifth parameter, information on the data flow is defined. The information on the data flow indicates that the details (a region corresponding to the length of the numerical value of the return value from the head) of a buffer handed over to the third parameter are copied to the details (a region corresponding to the length, which is obtained by multiply 2 to the return value, from the head) of a buffer handed over to a fifth parameter, when the fifth parameter of MultiByteToWideChar is not null and the return value is not 0.

The process of the shared library analysis unit 104 will be described below. The shared library analysis unit 104 is called when the instrumentation unit 102 loads basic blocks of the application program 103 or a shared library (DLL) linked thereto onto a memory. The shared library analysis unit 104 arranges the loaded basic blocks or API functions called by the shared library and generates a correlation table of the APIs defined in the API knowledge storage unit 108 and the start addresses thereof, that is, the function names of the API functions and the start addresses thereof. This correlation table is referred to as the API address map 105.

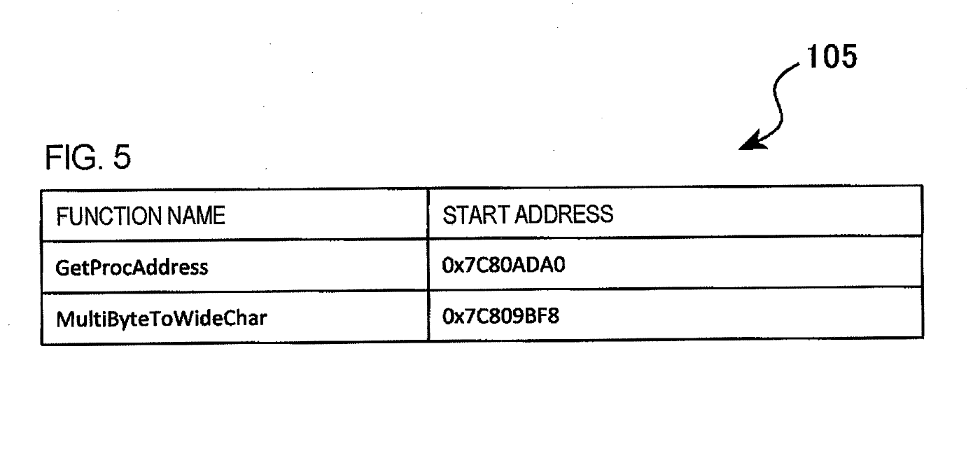

The API address map 105 stores pairs of a name of an API function defined in the API knowledge storage unit 108 and the start address thereof among the API functions directly or indirectly via another API function from the application program 103 to be executed (FIG. 5).

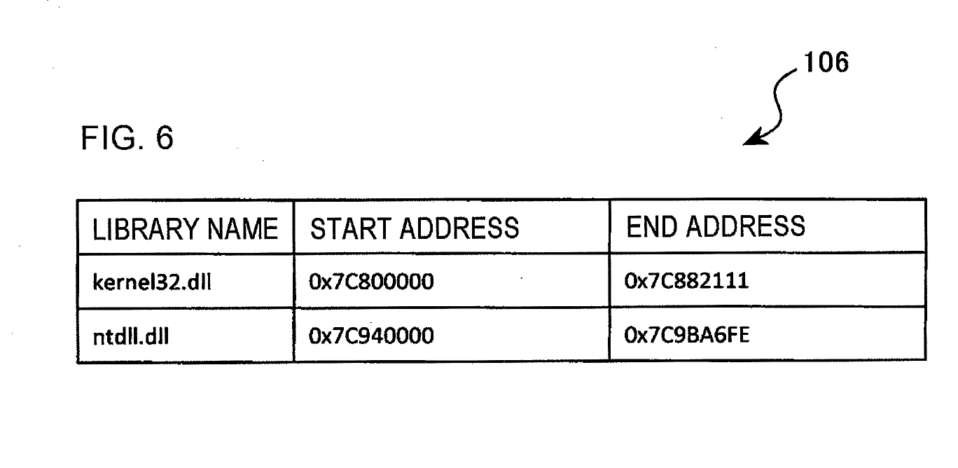

The shared library analysis unit 104 generates a share library address list 106 which is a set of pairs of the start address and the end address of all of the shared libraries called, as well as the API address map 105 (FIG. 6).

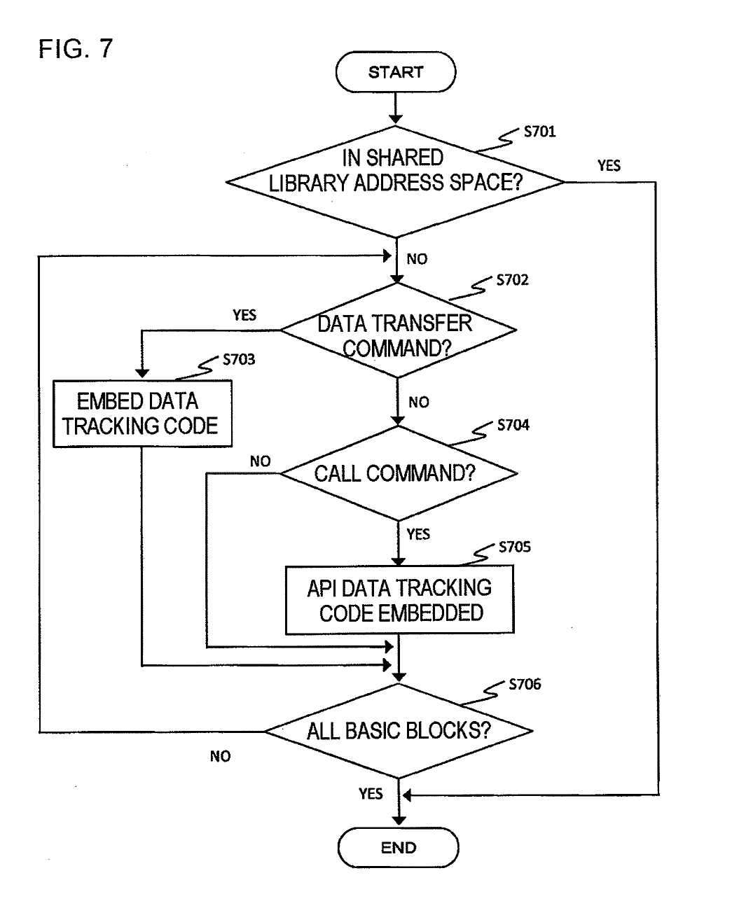

The data flow analysis process adding process of the dynamic data flow analysis process adding unit 107 will be described below with reference to FIG. 7. FIG. 7 is a flowchart illustrating the flow of operations when the dynamic data flow analysis process adding unit 107 performs a code embedding process on the basic blocks 1031.

The dynamic data flow analysis process adding unit 107 judges whether the start address of the basic block 1031 read by the instrumentation unit 102 is included between the start address and the end address of any set stored in the shared library address list 106 (S701). When the determination result is affirmative (YES in step S701), the dynamic data flow analysis process adding unit 107 recognizes that it is a process in a shared library and ends the flow of operations without performing the code embedding process on the corresponding basic block 1031.

On the other hand, when the determination result is negative (NO in step S701), the dynamic data flow analysis process adding unit 107 extracts a first instruction of the basic block. The dynamic data flow analysis process adding unit 107 embeds a code for causing a tag to propagate from a transfer source of data to a transfer destination thereof (S703), when the extracted instruction is a data transfer command (YES in step S702). Since this process is known in Non-patent Document 2 and the like, the details thereof will not be described. Examples of the data transfer command include copying, adding, or subtracting between registers, loading from the memory to a register, storing from a register to the memory, and push pop to a stack.

When the instruction extracted from the basic block is not the data transfer command (NO in S702), the dynamic data flow analysis process adding unit 107 judges whether the instruction is a call command (function call command) or not (S704). When it is judged that the instruction is a call command (YES in S704), the dynamic data flow analysis process adding unit 107 performs an API data tracking code embedding process (S705).

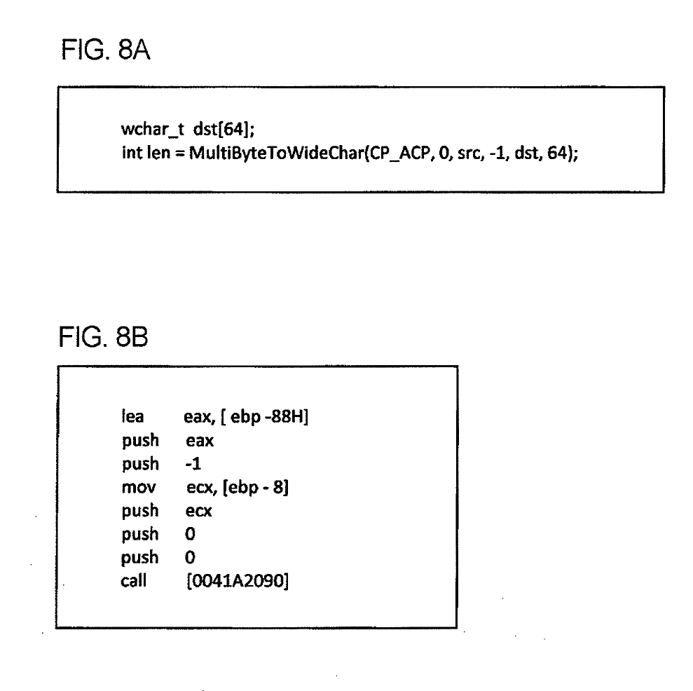

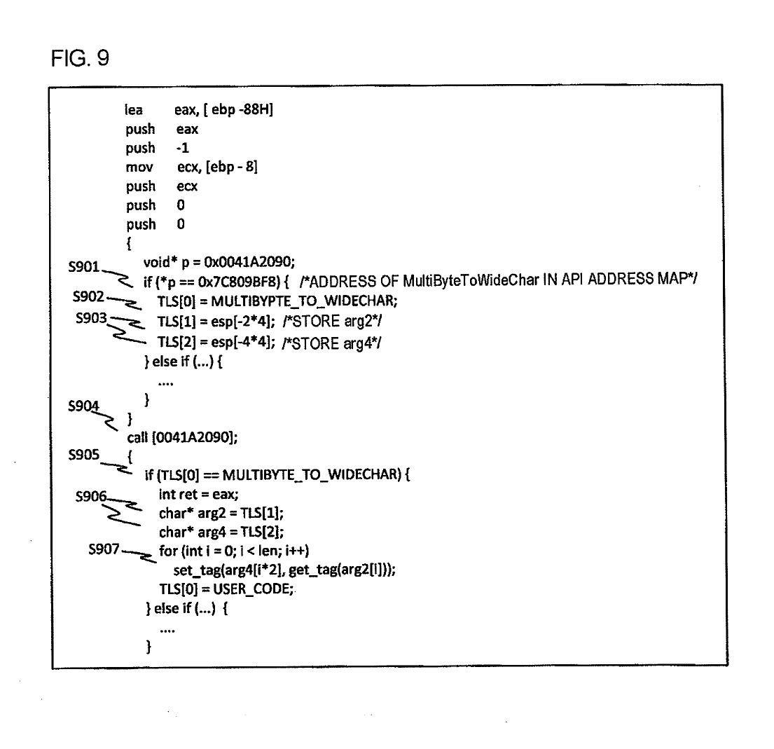

In the API data tracking code embedding process (S705), it is judged whether the value of the call destination address at the time of executing the call command is defined in the API address map (FIG. 5). When it is judged that the value is defined in the API address map, the dynamic data flow analysis process adding unit 107 embeds a code for temporarily storing the identifier of the API function and the values of parameters (these values are stored in a stack) just before the call command in a thread local area. When an API function is called, the dynamic data flow analysis process adding unit 107 embeds a code for causing a tag to propagate on the basis of the data (the values of parameters stored just before the call command and the information on the API signature) stored in the thread local area after the call command. The details of the code embedded in the API data tracking code embedding process (S705) will be described below with reference to FIGS. 8A, 8B, and 9.

FIG. 8A shows an example of a call of MultiByteToWideChar which is a function of a shared library. At the time of the function call of a shared library, the executable code as shown in FIG. 8B is executed when it is executed on an x86 architecture. FIG. 9 shows an example of an executable code when the dynamic data flow analysis process adding unit 107 embeds an API tracking code in the executable code shown in FIG. 8B. For the purpose of facilitating the understanding, the embedded API tracking code is described in a C format which is surrounded with { } in FIG. 9.

In the API tracking code, the details of the address of the call command is checked just before the call command to judge whether it is an address defined in the API address map (FIG. 5). In this embodiment, since the parameters of the call command is an indirect address [0041A2090], the details of the address “0041A2090” is checked just before the call command to judge whether it is an address defined in the API address map (FIG. 5) (S901).

When the address of the call command is defined in the API address map, it is recorded in the thread local area that the API function is called (S902). The details of the data flow appearing in the API signature are stored in the thread local area (S903) on the basis of the API signature (FIG. 4) corresponding to the called function. In this embodiment, when the address of the call command is equal to the address “0x7C809BF8” of the function MultiByteToWideChar, it is recorded in the thread local area that the function MultiByteToWideChar is called (S902). The third parameter and the fifth parameter handed over to the function MultiByteToWideChar are stored in the array TLS in the thread local area (S903).

After the call command (S904), it is judged whether the API function is called on the basis of the data stored in the thread local area (S905). When it is judged that the API function is called, the tag is caused to propagate (S907) with reference to the values of parameters and the return values (which are stored in an eax register in the case of the x86) of the API functions stored in the thread local area (S906). Here, get_tag (x) represents a function of reading the tag corresponding to the address x and set_tag(x,t) represents a function of changing the value of the tag corresponding to the address x to t.

In this embodiment, when data stored in the thread local area indicates that the function MultiByteToWideChar is called (S905), TLS[1] and TLS[2] stored in the thread local area are referred to (S906). Thereafter, the tag propagation process is performed on the basis of TLS[1] and TLS[2] which the referred data (S907).

In the example shown in FIG. 9, the dynamic data flow analysis process adding unit 107 embeds the API data tracking code in an in-line manner before and after the call command, but the tracking process may be unified into a function and the function may be called. By unifying the tracking process into a function, the overhead is taken for the function call, but the code size of the overall code is reduced.

In the example of the executable code shown in FIG. 9, the determination of S901 is a linear search, but the invention is not limited to this example. For example, by performing the determination using a searcher for hash or the like, it is possible to achieve an increase in process speed.

The dynamic data flow analysis process adding unit 107 perform the above-mentioned processes (S702 to S705) on all the instructions included in the basic blocks (S706).

Through the above-mentioned series of processes, the tag propagation process is not sequentially performed in the called API function but the tag propagation process is performed on the basis of the API signature just after the function call. In this way, in this embodiment, by not sequentially performing the tag propagation process but performing the tag propagation process in a bundle (simultaneously performing the tag propagation process), the tag propagation process is not performed in the API function, so it is possible to raise the execution speed of the dynamic data flow analysis.

This embodiment is particularly effective for a case where the number of shared libraries as a target is relatively small, the API signature can be defined for all the functions mounted on the shared libraries, and a callback to a user-described code from a function mounted on the shared library is not present in the specification.

### Second Embodiment

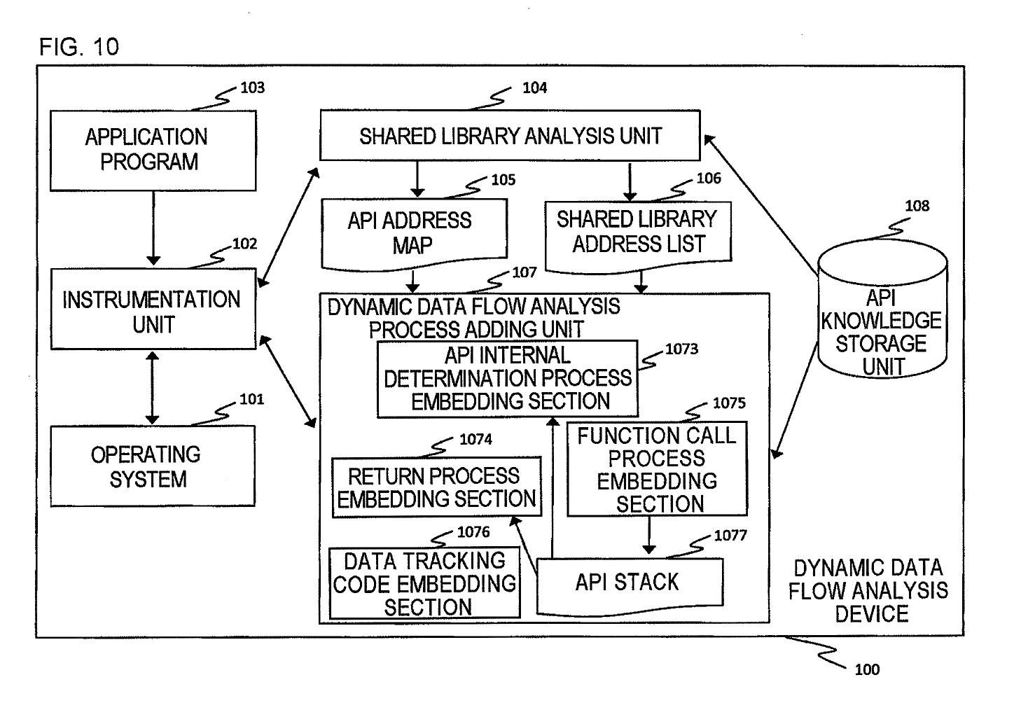

In a second embodiment of the invention, 2 types of code are embedded in the basic blocks and the executable codes are switched at the time of execution. The configuration of a dynamic data flow analysis apparatus according to this embodiment is shown in FIG. 10. In the dynamic data flow analysis apparatus 100 according to the second embodiment of the invention, the dynamic data flow analysis process adding unit 107 includes an API internal determination process embedding section 1073, a return process embedding section 1074, a function call process embedding section 1075, a data tracking code embedding section 1076, an API stack 1077. The different part of the operation of the dynamic data flow analysis apparatus 100 having this configuration from that in the first embodiment will be below.

Here, it is assumed in the first embodiment that all the functions in the shared libraries are defined in the API signature, but it is assumed in this embodiment that a part of the functions in the shared libraries are defined in the API signature. That is, in this embodiment, only some functions defined in the API signature among the functions in the shared libraries are the API functions. A user code is a program except the API functions, that is, a program of functions not defined in the API signature.

The API stack 1077 is formed in the thread local area at the time of executing a program. The API stack 1077 stores the history of a called function in a stack data format. The API stack 1077 stores an identifier of the API function or an identifier indicating the user code. The API stack 1077 stores an identifier indicating a user code in its initial state.

In the second embodiment of the invention, the instrumentation unit 102 embeds two kinds of codes in a basic block. At the time of executing the program, the two kinds of codes are appropriately switched. The switching of the executable codes is performed depending on whether the identifier of a record stored in the head of the API stack 1077 indicates a user code. The basic block which is executed when the identifier indicates the user code is referred to as a full tracking code, and the basic block which is executed when the identifier indicating the API function is referred to as an intra-API tracking code.

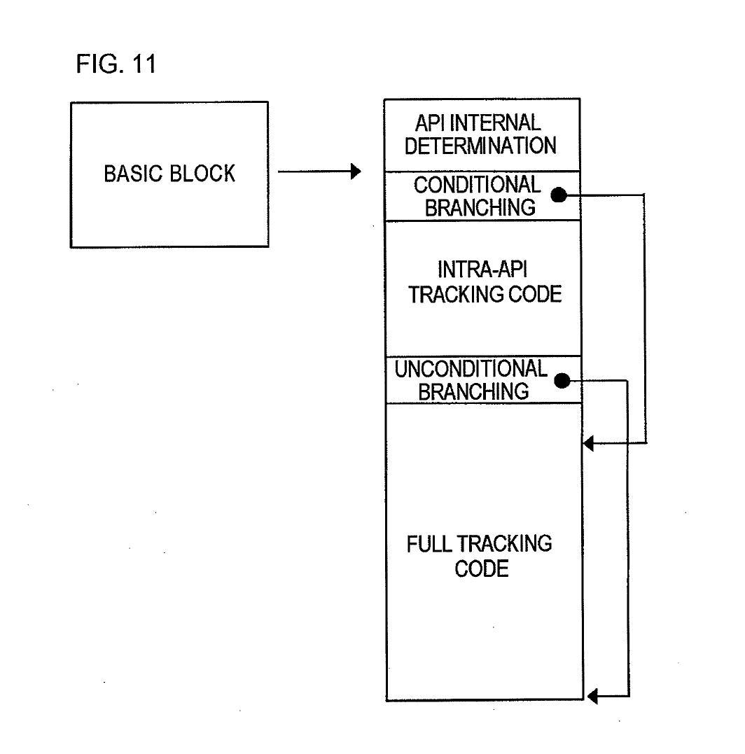

FIG. 11 shows an example of a basic block generated in this embodiment and the flow of processes. The “API internal determination process shown in FIG. 11 is a command to check an identifier of a record stored in the head of the API stack 1077. A conditional branching command just after the “API internal determination process” indicates a branch which is true when the result of the “API internal determination process” is a user code.

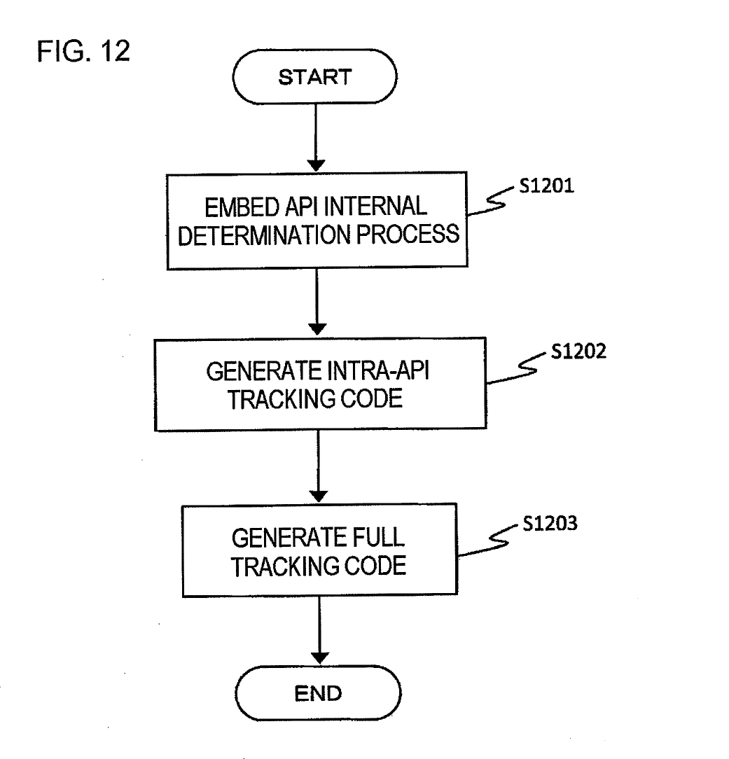

A basic block creating process in this embodiment will be described below with reference to FIG. 12. In the basic block creating process in this embodiment, first, the API internal judge process is embedded in the head of the basic block (S1201). Subsequently, a process of creating the intra-API tracking process is performed (S1202) and, finally, a process of creating a full tracking code is performed (S1203).

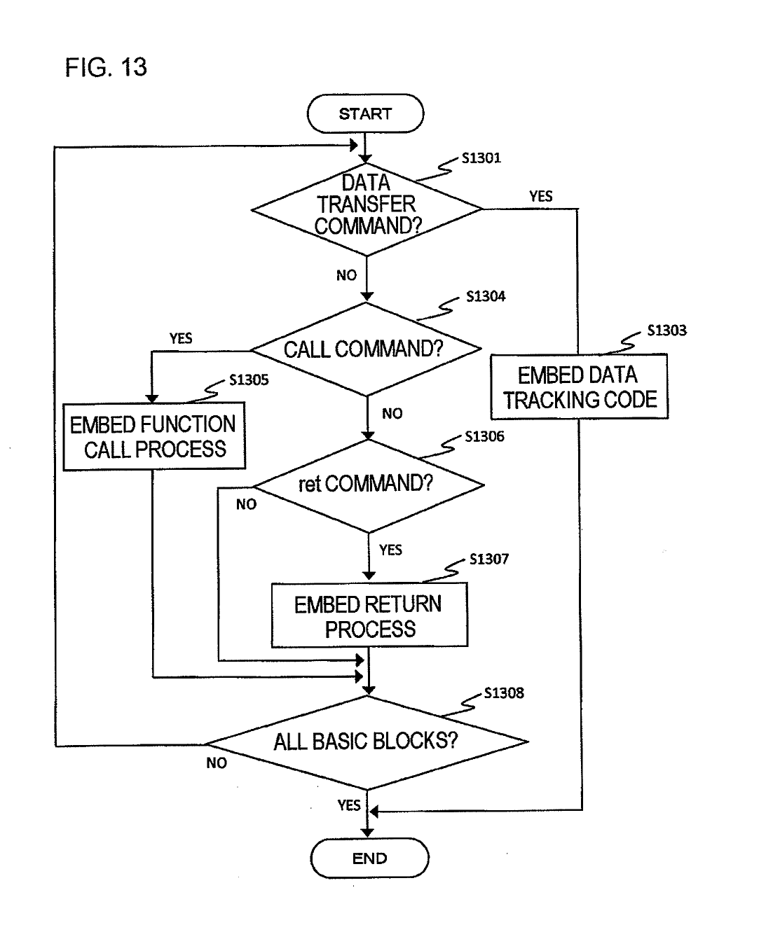

The process of creating a full tracking code will be described below with reference to FIG. 13. The dynamic data flow analysis process adding unit 107 extracts an instruction from a basic block and judges the instruction type, similarly to the first embodiment. When the instruction type is a data transfer command (YES in S1301), the data tracking code embedding section 1076 performs a data tracking code embedding process (S1303). When the instruction type is a call command (YES in S1304), the function call process embedding section 1075 performs a function call process embedding process (S1305). When the instruction type is a ret command (YES in S1306), the return process embedding section 1074 performs a return process embedding process (S1307). The data tracking code embedding process (S1303) is the same process as described in the first embodiment. The details of the function call process embedding process (S1305) and the return process embedding process (S1307) will be described below.

The function call process embedding process is different from the API data tracking code embedding process (FIG. 7) in the first embodiment and performed as follows.

When an identifier indicating a user code is stored in the head of the API stack 1077, it is judged whether the value of the call destination address at the time of executing a call command is a value defined in the API address map (FIG. 4). When it is defined in the API address map, a code for pushing a record including the identifier of the API function, a next address (return address) of the call command, and the parameter value (which is stored in the stack) just before the call command is embedded in the API stack 1077.

When the identifier indicating the API function is stored in the head of the API stack 1077, it is judged whether the value of the call destination address at the time of executing the call command is included in an address area stored in the shared library address list. When the value is not included in the address area, that is, when it is judged as a user code, a code for pushing a record including the identifier indicating the user code and the next address (return address) of the call command to the API stack 1077 is embedded.

The functional call process embedding section 1075 does not embed a code after the call command regardless of the value of the identifier stored in the head of the API stack 1077.

The code added in the return process embedding process will be described below. First, the record stored in the head of the API stack 1077 is checked, and the record is popped from the API stack 1077 when the address (return address) stored in the record is equal to the return destination of a return command stored in the head of a stack of an application process.

When the identifier stored in the popped record is an identifier indicating the API function, the tag propagation process is performed on the basis of the parameter value stored in the record and the data flow information of the API signature specified by the identifier.

The dynamic data flow analysis process adding unit 107 performs the above-mentioned processes (S1301 to S1307) on all the instructions included in the basic block (S1308).

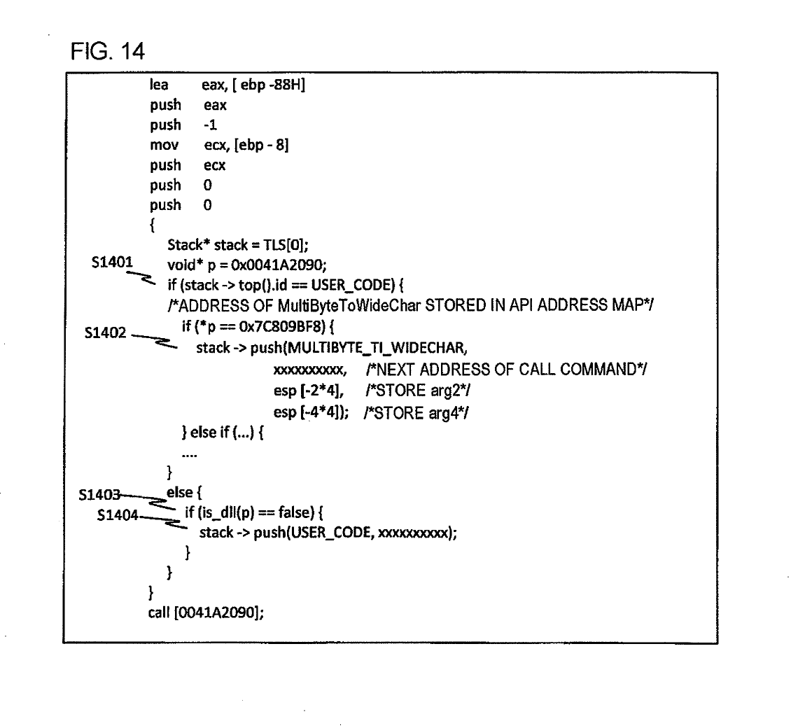

The function call process embedding process will be described below in more details with reference to FIG. 14. The code shown in FIG. 14 is an example of an executable code after the function call process embedding process is performed on the executable code shown in FIG. 8B.

In the function call process embedding process, when an identifier indicating a user code is stored in the head of the API stack 1077 (S1401), it is judged whether a call destination address of a call command is included in the API address map 105. When the call destination address is included in the API address map, the identifier of the API function, the next address of the call command, and the parameters (which are stored in the stack) of the function call indicated by the call command are stored in the API stack 1077 (S1402).

On the other hand, when the identifier indicating an API function is stored in the head of the API stack 1077 (S1403), it is judged whether the call destination of the call command is in an address space of the shared library. When the call destination is not included in the address space, it is considered as a callback to a user code and the identifier indicating the user code and the next address of the call command are stored in the API stack 1077 (S1404). In the example shown in FIG. 14, by calling a function of “is_dll” and referring to the shared library address list 106 in the function of “is_dll”, it is judged whether the call destination of the call command is included in the address space of the shared library. In this embodiment, the shared library address list 106 stores the addresses of the API functions.

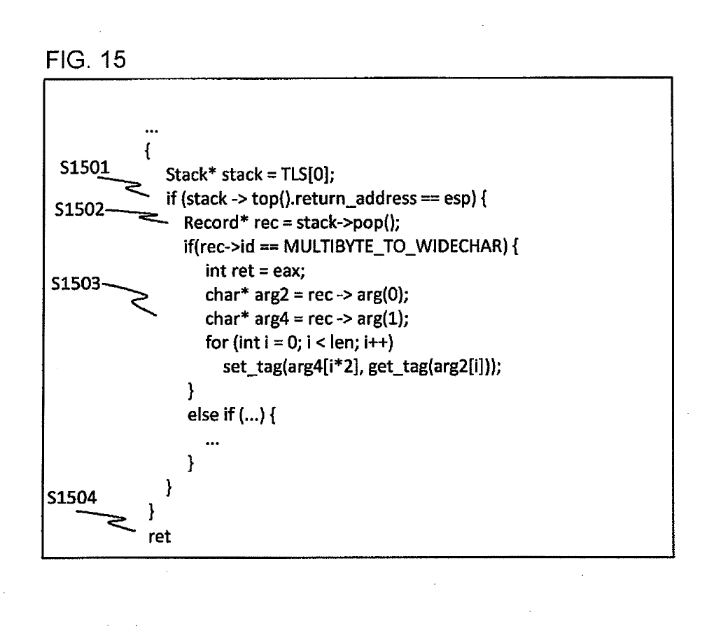

The return process embedding process will be described in detail below with reference to FIG. 15. The code shown in FIG. 15 is an example of an executable code after the return process embedding process is performed on the executable code of the function of the call destination.

In the example shown in FIG. 15, just before the return command ret (S1504), it is judged with reference to the return address stored in the API stack 1077 whether the return address is equal to the return destination (which is stored in a stack pointer esp) of the ret command (S1501). When it is judged that both are equal to each other, a record is popped from the API stack 1077 (S1502). When the identifier stored in the record indicates an API function, the tag propagation process based on the data flow information defined in the API signature of the API function is performed similarly to the first embodiment (S1503).

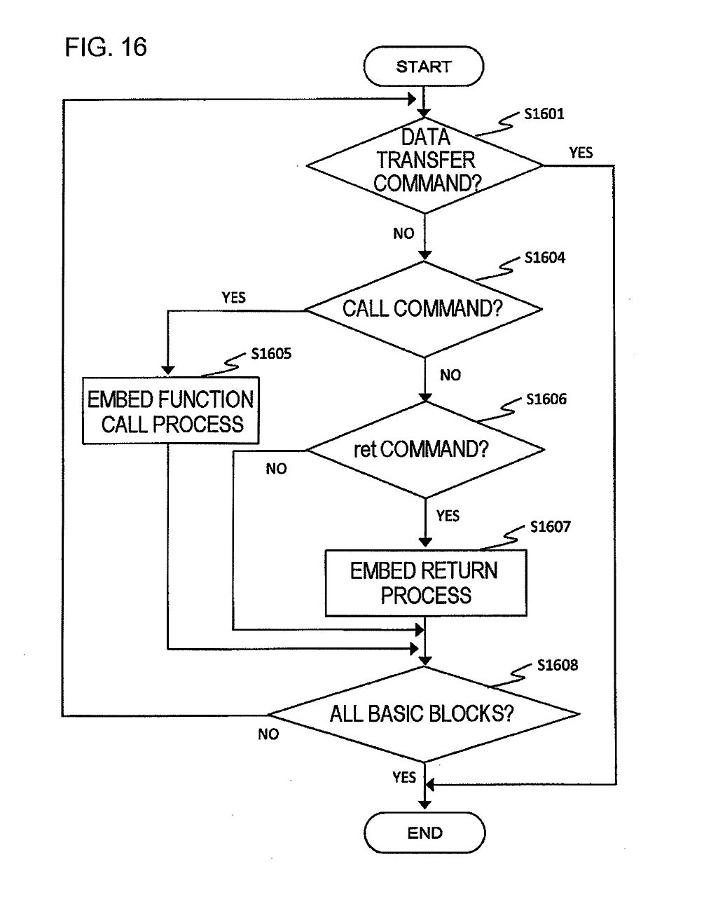

FIG. 16 is a flowchart illustrating the operation of creating an intra-API tracking code. Compared with the operation of creating the full tracking code shown in FIG. 13, nothing is performed in the case of the data transfer command. That is, in the intra-API tracking code, the data tracking code embedding process (S1303) is not performed. Accordingly, in the intra-API tracking code, the tag propagation process is not embedded at the time of giving the data transfer command. The other processes (S1601 to S1608) are the same as creating the full tracking code.

By the above-mentioned series of processes, the tag propagation process is not sequentially performed in the intra-API tracking code. Accordingly, in this embodiment, it is possible to skip the tag propagation process in the function defined in the API signature, thereby raising the execution speed of the dynamic data flow analysis.

In this embodiment, it is judged by the use of the API stack 1077 whether the function (API function) defined in the API signature is in call. Accordingly, when only a part of the functions in the shared libraries are defined in the API signature, the intra-API tracking code is executed at the time of executing the defined functions. On the other hand, at the time of executing a function not defined therein, the full tracking code is executed and the tag propagation process is performed on the basis of the code added in the data tracking code embedding process (S1303). Therefore, the dynamic data flow analysis apparatus correctly works when only some functions mounted on the shared libraries are defined in the API signature. An identifier indicating whether a user code is in execution is included in the API stack. Accordingly, when the API has a callback to the user code, the dynamic data flow analysis apparatus correctly works. However, since the processes are more complicated than the processes of the first embodiment, the execution speed is lower than that of the first embodiment.

In this embodiment, the functions in the shared libraries handing over and receiving data to and from a callback function cannot be defined in the API signature.

If such functions are defined, the tag propagation process is not performed in the functions and thus the data flow from the corresponding function to the callback is not tracked.

### Third Embodiment

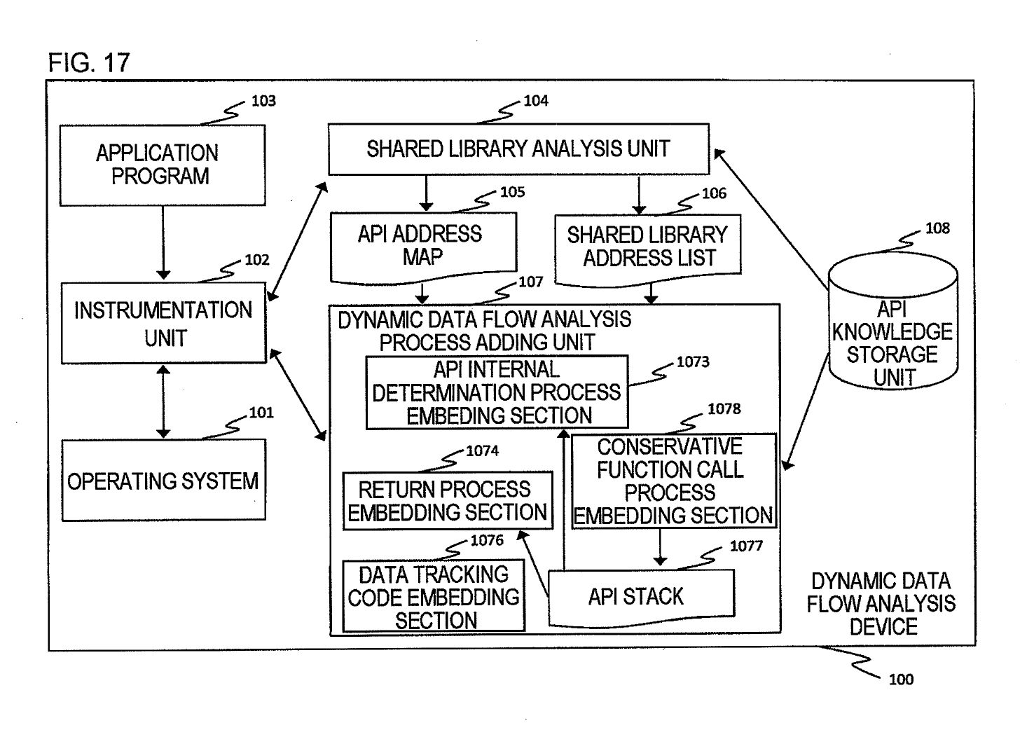

A third embodiment of the invention includes a conservative function call process embedding section 1078 instead of the function call process embedding section 1075 according to the second embodiment, as shown in FIG. 17. The conservative function call process embedding section 1078 embeds the conservative function call process. Then, the operation of the dynamic data flow analysis apparatus 100 according to this embodiment different from the second embodiment will be described.

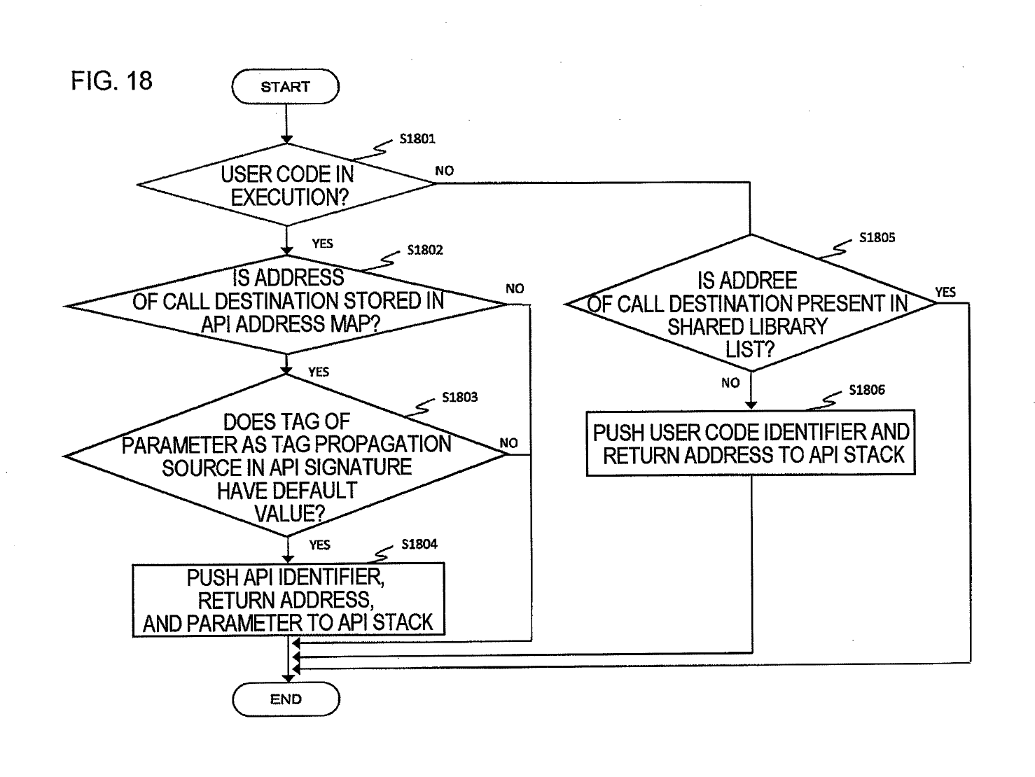

FIG. 18 is a flowchart illustrating the operation of the conservative function call process embedding section 1078 that embeds the conservative function call process. The conservative function call process embedding process is different from the second embodiment, in the process of S1803 of FIG. 18. That is, both are different from each other, in that it is judged whether the tag of a parameter serving as a propagation source of the tag is a default value, that is, an initial value (clean) and the process is changed on the basis of the determination result. The other processes (S1801, S1802, and S1804 to S1806) are the same as in the second embodiment.

In this embodiment, even when the address of a call destination indicates a function present in the API address map 105, it is judged with reference to the API signature of the function whether the tag of the parameter serving as a propagation source of the tag is a default value (clean) (S1803). When it is judged that the tag is a default value, the identifier of the API function, the return address, and the parameter are pushed to the API stack 1077 (S1804).

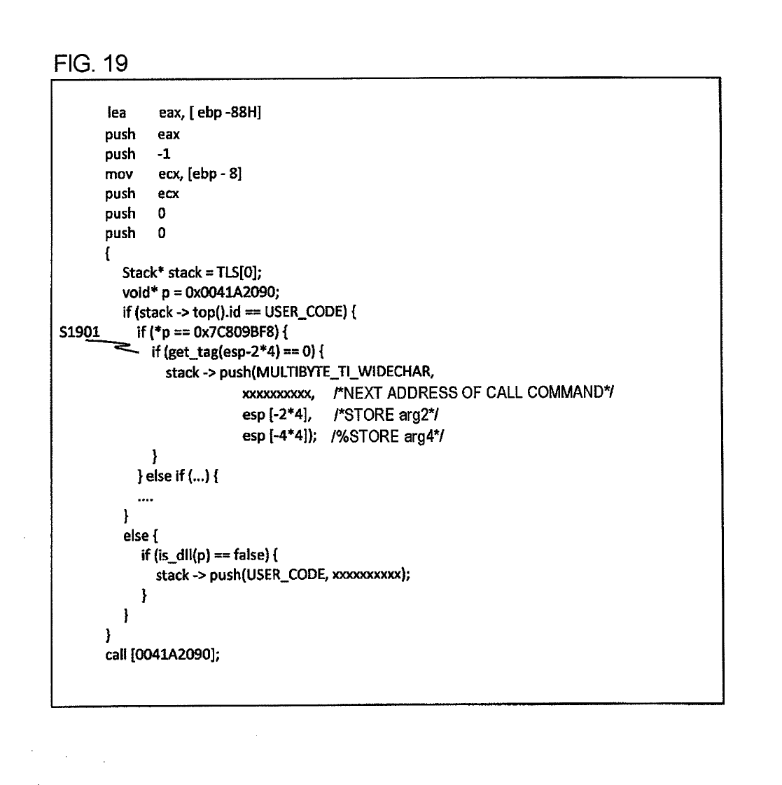

The executable code shown in FIG. 19 is an example where the conservative function call process embedding section 1078 embeds the conservative function call process in the executable code shown in FIG. 8B. The propagation source of the tag of the function MultiByteToWideChar is defined as only arg2 (the third parameter) in the API signature shown in FIG. 4. Accordingly, the tag corresponding to the address (esp-2*4) of arg2 is acquired and the record is pushed to the API stack 1077 when the value of the tag is a default value (S1901, “0” in FIG. 19).

When data to be tracked, that is, data having a tag other than the default value, is handed over to the API function by the above-mentioned series of processes, the record is not pushed to the API stack. In the API internal determination process, it is not judged to be a process in the API function and thus the full tracking code is executed. For this reason, the tag propagation process is sequentially performed in the API function. Accordingly, even when a callback occurs in the API function and data is handed over and received to and from the function of the callback destination, the tag propagates. However, in this embodiment, since the frequency by which the intra-API tracking code is executed is lower than that in the second embodiment, the execution speed is slightly lower than that in the second embodiment.

### Fourth Embodiment

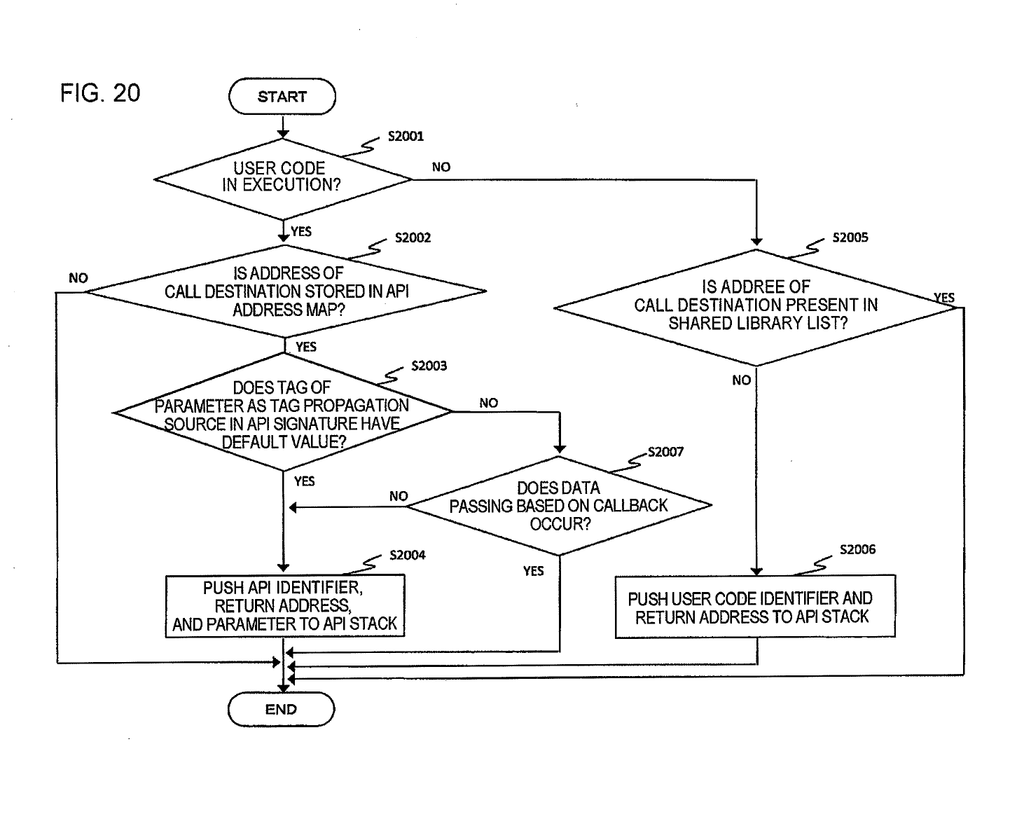

In a fourth embodiment of the invention, a flag indicating whether data passing based on a callback occurs is added to the API signature. A different part of the operation of the dynamic data flow analysis apparatus 100 of this embodiment from that in the third embodiment will be described with reference to the flowchart shown in FIG. 20.

In this embodiment, the API signature stores a flag indicating whether the data passing based on the callback occurs. In the conservative function call process embedding process, when the flag is present and the tag is not clean, it is considered with reference to the flag (S2007) that the data passing based on the callback does not occur. In this case, the identifier of the API function, the return address, and the parameter are pushed to the API stack. The other processes (S2001 to S2006) are the same as the third embodiment.

The number of frequencies by which the intra-API tracking code is executed is greater than that in the third embodiment due to the above-mentioned series of process. Accordingly, it is possible to raise the execution speed.

The invention is not limited to the above-mentioned embodiments, but may be modified in various forms without departing from the concept of the invention.

This application claims the priority based on Japanese Patent Application No. 2009-122345, field May 20, 2009, contents of which are incorporated herein by reference.

1. A dynamic data flow tracking method of dynamically tracking a data flow by setting a tag for data in a process and causing the tag to propagate with data passing in the process,
wherein a specification of the data passing between functions included in a shared library is defined as a signature, and
at least a part of the propagation of the tag between the functions is skipped by referring to the signature at the time of giving a call to the functions defined in the signature from a program.

2. The dynamic data flow tracking method according to claim 1, wherein the tag propagates in a bundle at the time of giving a call to the function.

3. The dynamic data flow tracking method according to claim 1, wherein it is judged whether an executable code which is a code in execution is included in the shared library, and at least a part of the propagation of the tag is skipped on the basis of the result of the judge.

4. The dynamic data flow tracking method according to claim 3, wherein it is judged whether the executable code is included in the shared library by comparing address information of the executable code with address information of the shared library.

5. The dynamic data flow tracking method according to claim 1, wherein when a call is given to a function defined in the signature from a function not defined in the signature, a return address and values of parameters are stored as history information, and a first state in which at least a part of the propagation of the tag is skipped is entered,
when a call is given to an address of a function not defined in the signature in the first state, the return address is stored as history information and a second state in which the propagation of the tag is not skipped is entered, and
newest history information is removed when a return destination is equal to the return address included in the newest history information at the time of return from the function call, and at least a part of the propagation of the tag is skipped when it is in the first state.

6. The dynamic data flow tracking method according to claim 5, wherein when a call is given to a function defined in the signature from a function not defined in the signature and only when the data which is a propagation source of the tag has a default value, the return address and the values of the parameters are stored as the history information and the first state is entered.

7. The dynamic data flow tracking method according to claim 5, wherein information on whether a callback is given to a function not defined in the signature from a function defined in the signature and data handed over to the function defined in the signature should be should be handed over with the callback is defined in the signature, and
wherein when the tag of data as a propagation source of the tag defined in the signature has a default value or when the tag does not have a default value and data is not handed over with the callback, the return address and the values of the parameters are stored as the history information and the first state is entered.

8. A dynamic data flow tracking program for causing a computer to perform a dynamic data flow tracking operation of dynamically tracking a data flow by setting a tag for data in a process and causing the tag to propagate with data passing in the process, wherein a specification of the data passing between functions included in a shared library is defined in a signature, and
wherein at least a part of the propagation of the tag between the functions is skipped by referring to the signature at the time of giving a call to the functions defined in the signature from a program.

9. The dynamic data flow tracking program according to claim 8, wherein the tag propagates in a bundle at the time of giving a call to the function.

10. The dynamic data flow tracking program according to claim 8, wherein it is judged whether an executable code which is a code in execution is included in the shared library and at least a part of the propagation of the tag is skipped on the basis of the result of the judge.

11. The dynamic data flow tracking program according to claim 10, wherein it is judged whether the executable code is included in the shared library by comparing address information of the executable code with address information of the shared library.

12. The dynamic data flow tracking program according to claim 8, wherein when a call is given to a function defined in the signature from a function not defined in the signature, a return address and values of parameters are stored as history information and a first state in which at least a part of the propagation of the tag is skipped is entered,
wherein when a call is given to an address of a function not defined in the signature in the first state, the return address is stored as history information and a second state in which the propagation of the tag is not skipped is entered, and
wherein newest history information is removed when a return destination is equal to the return address included in the newest history information at the time of return from the function call and at least a part of the propagation of the tag is skipped in the first state.

13. The dynamic data flow tracking program according to claim 12, wherein when a call is given to a function defined in the signature from a function not defined in the signature and only when the data which is a propagation source of the tag has a default value, the return address and the values of the parameters are stored as the history information and the first state is entered.

14. The dynamic data flow tracking program according to claim 12, wherein information on whether a callback is given to a function not defined in the signature from a function defined in the signature and data handed over to the function defined in the signature should be should be handed over with the callback is defined in the signature, and
wherein when the tag of data as a propagation source of the tag defined in the signature has a default value or when the tag does not have a default value and data is not handed over with the callback, the return address and the values of the parameters are stored as the history information and the first state is entered.

15. A dynamic data flow tracking apparatus that dynamically tracks a data flow by setting a tag for data in a process and causing the tag to propagate with data passing in the process, comprising:
a storage unit for storing a signature in which a specification of the data passing between functions included in a shared library is defined; and
a dynamic data flow analysis process adding unit for adding a tag propagation process of skipping at least a part of the propagation of the tag between the functions by referring to the signature at the time of giving a call to the functions defined in the signature from a program.

16. The dynamic data flow tracking apparatus according to claim 15, wherein the dynamic data flow analysis process adding unit adds the tag propagation process of causing the tag to propagate in a bundle at the time of giving a call to before or after the function.

17. The dynamic data flow tracking apparatus according to claim 15, wherein the dynamic data flow analysis process adding unit judges whether an executable code which is a code in execution is included in the shared library and skips at least a part of the propagation of the tag on the basis of the result of the judge.

18. The dynamic data flow tracking apparatus according to claim 17, wherein the dynamic data flow analysis process adding unit judges whether the executable code is included in the shared library by comparing address information of the executable code with address information of the shared library.

19. The dynamic data flow tracking apparatus according to claim 15, wherein the dynamic data flow analysis process adding unit calls a process of storing a return address and values of parameters as history information and entering a first state in which at least a part of the propagation of the tag is skipped when a call is given to a function defined in the signature from a function not defined in the signature and storing the return address as history information and entering a second state in which the propagation of the tag is not skipped when a call is given to an address of a function not defined in the signature in the first state, and adds the called process to the program, and
wherein the dynamic data flow analysis process adding unit calls a process of removing newest history information when a return destination is equal to the return address included in the newest history information at the time of return from the function call and skipping at least a part of the propagation of the tag with reference to the signature in the first state and adds the called process to the program.

20. The dynamic data flow tracking apparatus according to claim 19, wherein the dynamic data flow analysis process adding unit adds a process of storing the return address and the values of the parameters as the history information and entering the first state when a call is given to a function defined in the signature from a function not defined in the signature and only when the data which is a propagation source of the tag has a default value to the program as the call source,.

21. The dynamic data flow tracking apparatus according to claim 19, wherein the signature information includes information on whether a callback is given to a function not defined in the signature from a function defined in the signature and data handed over to the function defined in the signature should be should be handed over with the callback, and
wherein the dynamic data flow analysis process adding unit adds a process of storing the return address and the values of the parameters as the history information and entering the first state when the tag of data as a propagation source of the tag defined in the signature has a default value or when the tag does not have a default value and data is not handed over with the callback to the program as the call source.
